(19) United States
(12) Patent Application Publication
(10) Pub. No.: US 2026/0170535 A1
(43) Pub. Date: Jun. 18, 2026

(54) METHOD AND SYSTEM FOR ADAPTIVE ADVERTISEMENT INTEGRATION WITH WEBPAGES

(71) Applicant: Wix.com Ltd., Tel Aviv (IL)

(72) Inventors: Shachaf RODBERG, Tel Aviv (IL); Meir COHEN, Modi'in Illit (IL)

(21) Appl. No.: 19/424,203

(22) Filed: Dec. 18, 2025

Related U.S. Application Data
(60) Provisional application No. 63/735,329, filed on Dec. 18, 2024.
(60) Provisional application No. 63/920,677, filed on Nov. 19, 2025.

(51) Int. Cl. G06Q 30/0251; G06Q 30/0241

(52) U.S. Cl. CPC G06Q 30/0251; G06Q 30/0277

(57) ABSTRACT

A system for adaptive advertisement integration with webpages includes a chameleon ad handler, an artificial intelligence (AI) engine, and a site generation system. The chameleon ad handler analyzes visual properties of a target webpage to create a webpage style profile and reads the schema of a source chameleon advertisement object (CHA). The AI engine generates adaptation commands for the source CHA to create a display CHA visually aligned with the target webpage. Following a user interaction with the display CHA, the chameleon ad handler analyzes properties of the display CHA to create a display CHA style profile and instructs the AI engine. The AI engine then generates a blueprint for a personalized landing page according to the display CHA style profile. The site generation system constructs the personalized landing page according to the blueprint, creating a visually consistent user journey from advertisement to landing page.

### CROSS REFERENCE TO RELATED APPLICATIONS

This application claims priority from U.S. provisional patent applications No. 63/735,329, filed Dec. 18, 2024, and 63/920,677, filed Nov. 19, 2025, which are incorporated herein by reference.

### FIELD OF THE INVENTION

The present invention relates to website building systems generally and to digital advertising in particular.

### BACKGROUND OF THE INVENTION

In the current digital landscape, a wide variety of tools and platforms exist for the creation and management of online content. Website building systems (WBSs), for example, provide environments for users to design, build, and operate websites. These platforms often support visual editing systems that allow for the construction of complex and aesthetically diverse webpages.

It is a widespread practice for websites to incorporate online advertisements. These advertisements are displayed to users within the context of a webpage and can originate from numerous sources, such as different companies, brands, or automated ad exchanges. The visual characteristics of these advertisements, including their color schemes, typography, and branding elements, are typically defined by their respective creators.

The user journey in digital advertising often involves interaction across multiple platforms. For instance, a user may encounter various advertisements, such as social media posts, interactive videos, or banner ads, on a first website or application. Upon interacting with one of these advertisements, the user is typically directed to a second web asset, which is commonly a landing page or a broader brand website. This landing page is a singular destination designed to receive traffic from multiple, distinct advertising sources and campaigns. The brand owner typically manages the content and design of this destination page.

### SUMMARY OF THE PRESENT INVENTION

There is therefore provided, in accordance with a preferred embodiment of the present invention, a system for adaptive advertisement integration with webpages, the system including at least one processor and a website building system (WBS) running on the at least one processor. The WBS includes a chameleon ad handler, an artificial intelligence (AI) engine, and a site generation system. The chameleon ad handler is configured to analyze visual properties of a target webpage to create a webpage style profile and to read the schema of a source chameleon advertisement object (CHA). The artificial intelligence (AI) engine is configured to generate adaptation commands for the source CHA according to the webpage style profile and schema to generate a display CHA visually aligned with the target webpage according to the webpage style profile, where the chameleon ad handler is further configured to detect a user interaction with the display CHA, and in response to the user interaction, to analyze properties of the display CHA to create a display CHA style profile and to instruct the AI engine to generate a blueprint for a personalized landing page according to the display CHA style profile. The site generation system is configured to construct the personalized landing page according to the blueprint.

Moreover, in accordance with a preferred embodiment of the present invention, the source CHA includes an ad handler with an associated CHA AI configured to provide artificial intelligence support for the source CHA.

Further, in accordance with a preferred embodiment of the present invention, the chameleon ad handler includes an interface and event handler, an asset and state manager, and an adaptation module. The interface and event handler manages data and command signals between the system, the source CHA, the webpage and the display CHA. The asset and state manager stores and manages data defining the source CHA. The adaptation module is configured to determine changes required to visually align the source CHA with the target webpage, the adaptation module to further determine the blueprint for the landing page according to the display CHA style profile.

Still further, in accordance with a preferred embodiment of the present invention, the interface and event handler includes a schema reader and an event listener. The schema reader is configured to read the schema of the source CHA, and the event listener is configured to detect the user interaction with the display CHA.

Additionally, in accordance with a preferred embodiment of the present invention, the adaptation module includes an internal data retriever, a website/ad analyzer, a style negotiator, and an AI handler. The internal data retriever is configured to retrieve attributes of the target webpage from a local content management system. The website/ad analyzer is configured to analyze at least one of: the target webpage and the display CHA to determine a webpage style profile and a display CHA style profile accordingly. The style negotiator is configured to perform an optimization calculation that reduces visual discrepancy between the display CHA and the target webpage by determining a set of modifications for both while preserving each party's brand identity. The AI handler is configured to generate a prompt for the AI engine according to at least one of: the webpage style profile and the display CHA style profile.

Moreover, in accordance with a preferred embodiment of the present invention, the schema of the source chameleon advertisement object includes a set of protected brand elements and a list of modifiable elements.

Further, in accordance with a preferred embodiment of the present invention, the AI handler includes a prompt generator and an output receiver. The prompt generator is configured to assemble a structured prompt for the AI engine by populating a predefined template with at least one of: the webpage style profile and the display CHA style profile. The output receiver is configured to receive and parse an output from the AI engine, the output including the adaptation commands.

Still further, in accordance with a preferred embodiment of the present invention, the blueprint for the personalized landing page is a machine-readable instruction set including a definition of a content structure and a set of associated styling rules for the personalized landing page.

Additionally, in accordance with a preferred embodiment of the present invention, the website/ad analyzer performs at least one of: deconstructing foundational code of the target webpage to parse its structural hierarchy, performing a color analysis of visible elements to determine a dominant color palette, and conducting a typography analysis to identify font families, sizes, and weights to establish a typographic hierarchy.

Moreover, in accordance with a preferred embodiment of the present invention, the asset and state manager is further configured to maintain multiple states of the source CHA, the multiple states including its original state, its live adapted state after modification by the adaptation module, and a history of previous states, thereby enabling A/B testing between different adaptations.

There is therefore provided, in accordance with a preferred embodiment of the present invention, a method for adaptive advertisement integration with webpages. The method includes analyzing visual properties of a target webpage to create a webpage style profile, reading the schema of a source chameleon advertisement object (CHA), generating using artificial intelligence, according to the webpage style profile and schema, adaptation commands for the source CHA to generate a display CHA visually aligned with the target webpage, and in response to a user interaction with the display CHA, analyzing properties of the display CHA to create a display CHA style profile, and generating using artificial intelligence, a blueprint for a personalized landing page according to the display CHA style profile, and constructing the personalized landing page according to the blueprint.

Further, in accordance with a preferred embodiment of the present invention, generating the display CHA further includes providing artificial intelligence support within the source CHA to ensure the adaptation commands are implemented according to brand consistency rules.

Still further, in accordance with a preferred embodiment of the present invention, the method further includes managing data and command signals between the source CHA, the target webpage, and the display CHA, storing and managing data defining the source CHA, and determining changes required to visually align the source CHA with the target webpage.

Additionally, in accordance with a preferred embodiment of the present invention, the managing data and command signals includes reading the schema of the source CHA, and detecting the user interaction with the display CHA.

Moreover, in accordance with a preferred embodiment of the present invention, the determining changes required to visually align the source CHA with the target webpage includes retrieving attributes of the target webpage from a local content management system, analyzing at least one of: the target webpage and the display CHA to determine the webpage style profile and the display CHA style profile accordingly, performing an optimization calculation that reduces visual discrepancy between the display CHA and the target webpage by determining a set of modifications for both while preserving each party's brand identity, and generating a prompt according to at least one of: the webpage style profile and the display CHA style profile.

Further, in accordance with a preferred embodiment of the present invention, the schema includes a set of protected brand elements and a list of modifiable elements, and where the generating adaptation commands is further based on the protected brand elements and the list of modifiable elements.

Still further, in accordance with a preferred embodiment of the present invention, the generating a prompt includes assembling a structured prompt by populating a predefined template with at least one of: the webpage style profile and the display CHA style profile, and receiving and parsing an output including the adaptation commands.

Additionally, in accordance with a preferred embodiment of the present invention, the generating a blueprint includes generating a machine-readable instruction set including a definition of a content structure and a set of associated styling rules for the personalized landing page.

Moreover, in accordance with a preferred embodiment of the present invention, the analyzing includes at least one of: deconstructing foundational code of the target webpage to parse its structural hierarchy, performing a color analysis of visible elements to determine a dominant color palette, and conducting a typography analysis to identify font families, sizes, and weights to establish a typographic hierarchy.

Further, in accordance with a preferred embodiment of the present invention, the storing and managing data further includes maintaining multiple states of the source CHA, the multiple states including its original state, its live adapted state, and a history of previous states, thereby enabling A/B testing between different adaptations.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of an advertisement displayed on three different websites;

FIG. 2 is a schematic diagram of how individual advertisements are directed to a different landing page which is generated especially according to the advertisement; constructed and operative in accordance with the present invention;

FIG. 3 is a schematic illustration of an adaptive advertisement integration system; constructed and operative in accordance with the present invention;

FIG. 4. is a schematic illustration of the elements of the chameleon ad handler of FIG. 3, constructed and operative in accordance with the present invention; ...

FIG. 5 is a schematic illustration of the elements of the interface and event handler of FIG. 3, constructed and operative in accordance with the present invention;

FIG. 6 is an example of a standardized format for a chameleon advertisement, constructed and operative in accordance with the present invention;

FIG. 7 is a schematic illustration of the elements of the adaptation module of FIG. 4, constructed and operative in accordance with the present invention;

FIG. 8 is an example prompt to initiate a call to the artificial intelligence (AI) engine of FIG. 1 to determine adaptation instructions for an advertisement to a website, constructed and operative in accordance with the present invention;

FIG. 9 is an example prompt to initiate a call to the AI engine of FIG. 1 to determine instructions for a creating a landing page for a particular advertisement, constructed and operative in accordance with the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

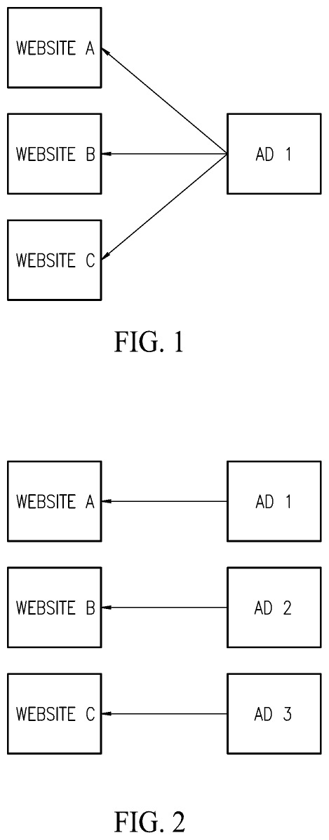

Applicant has realized that traditional approaches to incorporating advertisements on websites result in significant challenges, leading to visual inconsistencies and a disjointed user experience. Advertisements created by different companies, brands, and automated systems often do not align with the unique graphical and design language of the webpage on which they are displayed. This misalignment in color palettes, typography, and overall branding can create a discernible break in the graphic flow of the page, causing advertisements to appear misplaced. This visual dissonance can hinder the effectiveness of the advertisements and limit their potential to successfully engage the target audience. Reference is now made to FIG. 1 which shows how the same advertisement (AD1) can be displayed on three different websites.

Applicant has further realized that the user's journey from advertisement exposure to conversion is often fraught with inconsistencies and missed opportunities. Regardless of the variety and specificity of an initial advertisement, brands typically direct user traffic to a singular, generic landing page. This one-size-fits-all approach fails to resonate with the user's specific interaction and the context of the originating ad. This disconnect between the ad and the subsequent landing page can result in diminished user engagement, a loss of conversion momentum, and unrealized conversion potential for advertisers and brands. The common practice of creating unique landing pages for each ad variation is both costly and resource-intensive and thus is not a scalable solution to this widespread problem.

Applicant has realized that the above mentioned limitations can be overcome by a system that creates a dynamic, adaptive integration between advertisements and the web assets they interact with. This is achieved through two primary concepts. The first concept transforms a standard advertisement from a static graphic file into a programmatic, executable object capable of real-time self-modification which visually aligns with a website. The second concept enables the real-time generation of personalized web assets, such as landing pages, which are thematically and visually aligned with the specific advertisement that directs traffic to them as is illustrated in FIG. 2 to which reference is now made. In FIG. 2 each individual advertisement (Ads 1, 2 and 3) is each directed to a different website or landing page which is generated especially according to the advertisement.

To address the challenge of visual inconsistency, the inventive system may treat an advertisement as a “chameleon ad” (CHA), a runnable object with its own executable code components (e.g., JavaScript, HTML, CSS) and API (application programming interface).

Instead of being a passive element, the CHA actively participates in its own presentation. The system may use artificial intelligence (AI) to analyze the visual properties of the target website or one of its pages, such as its color schemes, typography hierarchies, and layout patterns, to create a webpage style profile. This profile is then communicated to the CHA object, which processes the data and modifies its own design parameters to seamlessly blend with the webpage's aesthetic. This process represents a specific, unconventional data processing pipeline that transforms a generic ad object into a bespoke, integrated component of the webpage, thereby improving the user experience and the functioning of the ad-delivery system.

Furthermore, to solve the problem of disjointed and generic conversion funnels, the system introduces the concept of a “chameleon site.” When a user interacts with a specific ad, the system leverages a generative artificial intelligence (AI) to automatically construct a new, personalized landing page or other web asset in real time. The system extracts key elements, including content, media, and branding information from the directing ad as a display CHA style profile and uses them as a blueprint of instructions for the technical design for a landing page that continues the same visual language and messaging as the ad. By deriving layout, color palette, typography, and primary messaging from the ad itself, the generated web asset maintains continuity between the advertisement and the landing page in a manner that static, prebuilt landing pages do not provide.

This ordered combination of analysis, data transformation, and real-time generation constitutes a specific improvement to computer-implemented advertising workflows. The system automates the integration of disparate digital assets by converting generic ad objects and webpage templates into structured representations with explicit style profiles and adaptation commands. This reduces the amount of manual configuration and ad-hoc scripting typically required to integrate advertisements with webpages and to create tailored landing pages and reduces configuration errors by automatically enforcing brand-protection constraints. The generation of new, structured, machine-readable documents, including the adapted CHA object and the generated landing page, provides concrete outputs of this improved computer process.

Furthermore, while the use of AI may present noticeable overhead, there can be several ways to minimize it such as having ads implement a specific, known in advance, list of branding, so that websites can be prebuilt with these brands.

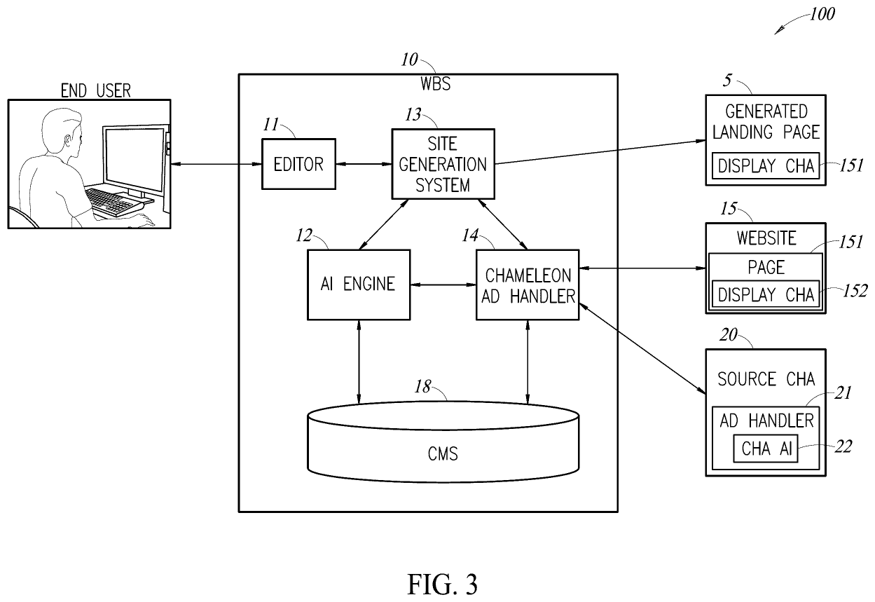

Reference is now to FIG. 3 which illustrates an adaptive advertisement integration system 100, according to an embodiment of the present invention. System 100 may be used to create adaptive graphical content and web assets that integrate seamlessly with the aesthetics and functionality of a website.

System 100 may comprise a website building system (WBS) 10. WBS 10 may further comprise an editor 11, an artificial intelligence (AI) engine 12 for analyzing web assets and generating content; a site generation system 13 for constructing new websites and pages; a chameleon ad handler 14 to orchestrate the adaptation and generation flows when adapting a CHA and a content management system (CMS) 18 which acts as a central repository for CHA information such as default properties, protected brand elements, and executable code for adaptation. CMS 18 may also store general brand rules as well as WBS 10 data of websites built with WBS 10, such as page structures, text content, images, user-generated content, navigation menus, and section layouts etc. and components and templates for building new landing pages. CMS 18 may further store prompt templates used to query AI engine 12 as described in more details herein below.

In a first operational concept, system 100 may transform a source CHA 20 (i.e., a static graphic file) into a visually harmonized or aligned display CHA 152 for display on a page 151 of website 15. In this scenario, WBS 10 may interact with a host website 15. AI engine 12 may analyze website 15 and may provide chameleon ad handler 14 with adaptation commands to send to ad handler 21, the API wrapper for source CHA 20. This process transforms a source CHA 20 (i.e., a static graphic file) into a visually harmonized display CHA 152 on website 15. In the second concept, upon user interaction with display CHA 152, display CHA 152's data is used by AI engine 12 to design a new, personalized generated landing page 5, which is assembled by site generation system 13 for a better display of display CHA 152. It will be appreciated that ad handler 21 may comprise a CHA artificial intelligence (AI) to provide artificial intelligence support for source CHA 20 as described in more detail herein below.

In one embodiment, system 100 may operate within the WBS 10 environment, though it can be applied in other types of visual editing systems.

In further embodiments, system 100 may be expanded beyond traditional websites and pages to a plurality of other digital and interactive platforms to provide a contextually harmonized user experience. For instance, in the context of mobile application advertising, system 100 may analyze the application's native user interface themes and color schemes to adapt an advertisement's styling for seamless integration with frameworks such as iOS UIKit and Android Material Design. Similarly, within email marketing platforms, system 100 may detect a recipient's client theme, such as a light or dark mode, and modify the advertisement's design to match those preferences. This principle also may be extended to smart television and streaming platforms, where system 100 may analyze the color palette and mood of video content to adapt overlay advertisements, thereby complementing the viewing experience. Furthermore, system 100 may be implemented in immersive environments. In augmented reality (AR) applications, system 100 may analyze real-world environmental lighting and colors to adapt virtual advertisement objects, causing them to blend naturally with the user's physical surroundings. In gaming environments, system 100 may analyze a game's unique visual style and user interface elements to adapt in-game advertisements, making them appear as an integrated component of the game's aesthetic. In yet another embodiment, on social media platforms, system 100 may analyze a user's profile theme and post patterns to adapt sponsored content to match that user's specific aesthetic preferences, creating a more personalized and less intrusive advertising experience.

Other embodiments may include conversational applications, such as a chat environment (AI-based or otherwise), that provide communication via text, audio, or video (or other means) with its users and embedded presence applications, such as social network pages.

Although the description below focuses on the display of CHAs in conjunction with web pages, system 100 may be applied to other sources or streams of information and (formatted) text and media (including non-static media) displayed in conjunction with pages, such as newsfeeds, live video feeds, RSS feeds, etc.

It will be appreciated that during website creation or editing, a site owner or designer defines the structure and content of website 15 using editor 11. A website is fundamentally composed of individual pages, each of which is separately displayed and contains various components organized within a hierarchical structure of containers. This structure can include specialized multi-page containers that display multiple “mini-pages,” each with its own set of components. The components themselves range from simple, atomic elements like text objects, buttons, and images, to more elaborate composite components such as galleries, and even complex third-party applications or entire e-shops. To maintain consistency, pages and their sections may utilize templates, including master pages or repeating headers/footers, with system 100 supporting inheritance between these elements. The specific arrangement of all these components within a page is defined as its layout.

In some embodiments, editor 11 may enable editing user 30 to provide hints, directives, prompt inputs, permissions, and other metadata that affect how chameleon ads and webpages interact. For example, such metadata may specify which chameleon advertisement (CHA) properties are permitted to be modified by website 15, which site-level properties can be influenced by a CHA, which CHA features are enabled, and how metadata of the site or CHA may be updated in response to user interactions.

It will be further appreciated that the data that WBS 10 sends to a source CHA 20 may be determined based on the type, content, branding properties, and other metadata of source CHA 20. By way of example, WBS 10 may provide to source CHA 20 one or more of: advertising demographic parameters, budget or pacing constraints, product catalog data, and associated metadata, and other site-specific or end-user-specific parameters. The source CHA 20 may take such information into account when determining its presentation and behavior and when supplying analytics or projected performance data back to WBS 10 or to an associated analytics subsystem.

It will be appreciated that the CHA is represented in FIG. 3 in two distinct functional roles to illustrate the two core concepts of system 100. In its first role, the CHA is shown as display CHA 152, situated within page 151 on host website 15. This represents the CHA in its runtime environment after it has successfully completed the adaptation process. Its purpose here is to be visually integrated and displayed to the end-user, acting as the target of the adaptation flow where system components modify its appearance. In its second role, the CHA is represented as the standalone source CHA 20. This depicts the same CHA acting as the trigger and data source for the second concept. Upon user interaction with display CHA 152, display CHA 152's properties, represented by source CHA 20, are extracted and used as the input for generating new generated landing page 5, thus serving as the source for the generation flow. In summary:

System 100 may adapt an ad C to the page P it is displayed on.

System 100 may adapt a page P to an ad C to be displayed on the page P.

System 100 may adapt both page P and ad C to each other, so each them is adapted to some extent (to P* and C*), and the combined P* and C* are a better match.

When an ad C is displayed on page P1 and is selected/clicked, system 100 may adapt or create a specific landing page P2 linked from C (and with P2 matching the style of C or adapted according to parameters of the user of the original page P1). P2 may typically be part of a different site, possibly hosted on a different WBS than P1.

In some scenarios, ad C is displayed on the same site that hosts landing page P2, while in other scenarios ad C is displayed on a different website or application than the site that hosts P2. In the latter case, system 100 may cause ad C to convey information to landing page P2 using one or more communication mechanisms, such as information encoded in a uniform resource locator (URL) referrer field, information carried in URL parameters, and/or a dedicated communication protocol, for example via a web service, application programming interface (API), or plug in interface (SPI). The conveyed information may include, for example, identifiers of the ad or campaign, parameters describing the creative, and context information about the host page or application.

When the site that displays ad C is hosted by WBS 10, WBS 10 may augment the conveyed information with additional parameters related to the user, based on recorded or stored knowledge of that user within WBS 10, such as past interactions, account attributes, or declared preferences, subject to applicable privacy and legal constraints. These enriched parameters may then be taken into account when adapting or generating landing page P2.

In some embodiments, system 100 may be implemented on a single instance of WBS 10. In other embodiments, system 100 may be implemented using multiple cooperating website building systems. For example, a first website A that displays ad C may be hosted on a first website building system WBS 1, while a second website G that includes landing page P2 is hosted on a second website building system WBS 2. System 100 may define a protocol and a method of communication that allows the multiple website building systems involved to communicate and coordinate the interaction and exchange of information between ad C and the target site, even when operating in a hybrid hosting environment. In yet another scenario, WBS 1 and WBS 2 may be the same website building system, or different instances of the same website building system.

As further detailed herein below, the adaptation may include changes of existing properties and parameters of an entity (or a portion thereof), as well as generating new sub-elements within an entity or completely new entity.

In some implementations, website 15 may support dynamic themes or color schemes that change over time, for example in response to explicit user preferences, device or browser settings, user-specific parameters, or time-of-day rules defined by the site owner. System 100 may treat the currently active theme as part of the style profile of website 15, such that the CHA and any generated landing pages remain visually harmonized even when the underlying theme is changed while the CHA is in use.

In a wide Internet world, millions of websites exist that are different from each other. Many websites decide to incorporate ads, but many companies, brands, artificial /telligence/ machine learning (AI/ML) models, and others create these ads. This means that the ads'colors, fonts, brand, and overall graphic language are different from the website that presents it to the user. As discussed herein above, chameleon ad handler 14 is responsible for both adapting a CHA to match a containing website 15 and determining CHA attributes in order to generate a matching landing page 5.

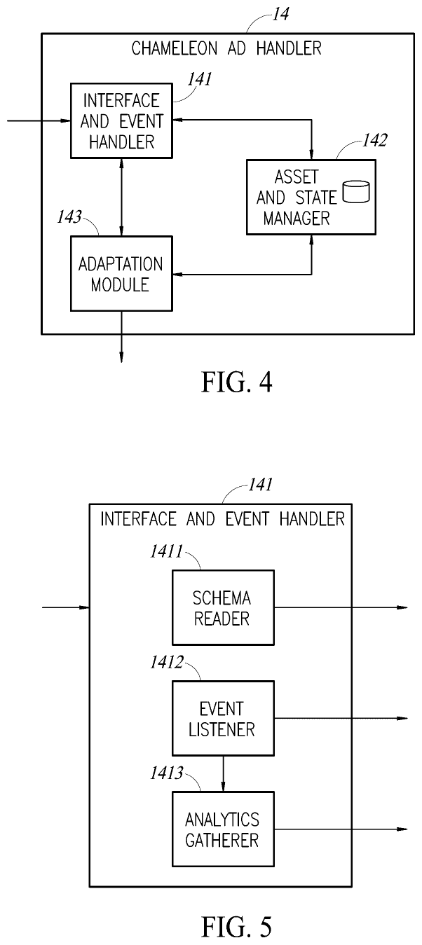

Reference is now made to FIG. 4 which illustrates the sub elements of chameleon ad handler 14. Chameleon ad handler 14 may comprise an interface and event handler 141, an asset and state manager 142 and an adaptation module 143. Interface and event handler 141 may further comprise a schema reader 1411, an event listener 1412 and an analytics gatherer 1413 as is illustrated in FIG. 5 to which reference is now made.

Interface and event handler 141 may function as a communication gateway for chameleon ad handler 14, managing all inbound and outbound data and command signals between either source CHA 20 or display CHA 152 and system 100.

In the context of adapting source CHA 20 to page 151, schema reader 1411 may communicate with source CHA 20 via an API or other messaging option. It may include methods such as a ReadProperties method, which may allow schema reader 1411 to read different graphic and behavior parameters that source CHA 20 has, such as a list of fonts used, a list of colors, an internal timeline of the CHA for time-dependent effects, internal objects from which the CHA is built, and a layout of its components including position, size, and display priority. The interface may further include an UpdateProperty method to receive instructions for changing a specific design parameter to a specific value, and an UpdateAll method to receive a comprehensive set of instructions for adapting CHA's entire visual language. Schema reader 1411 may also expose a RunAd method to receive a command that initiates the CHA's executable logic, such as an animation.

In some embodiments, the same API may further expose a DuplicateAd or similar method that, when invoked, may cause creation of a new CHA instance that inherits the schema and live state of an existing instance. This may allow a WBS or ad serving system to efficiently create additional, independently adaptable copies of a given display CHA 152 without reconstructing display CHA 152 from its original assets.

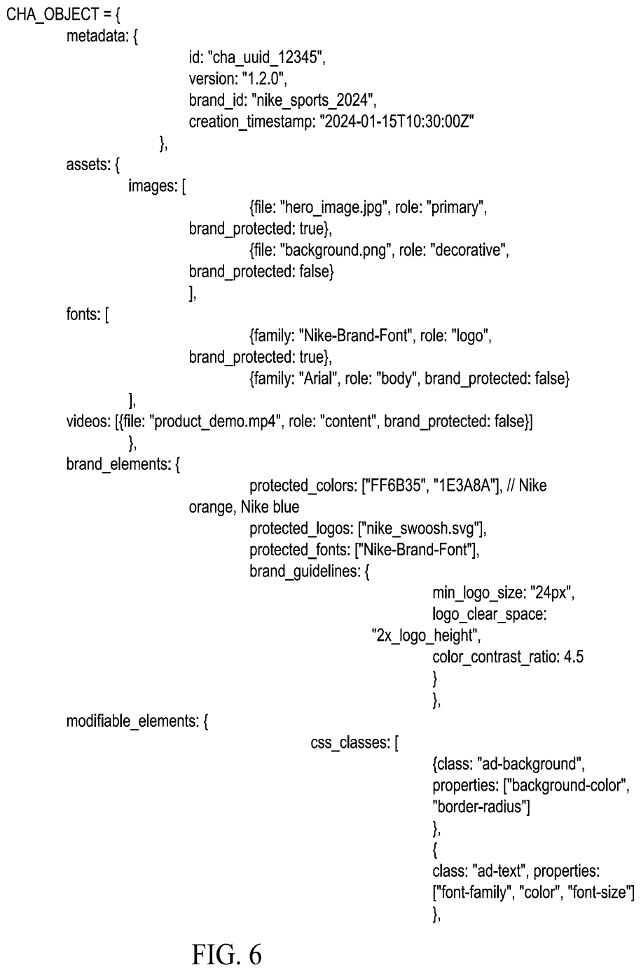

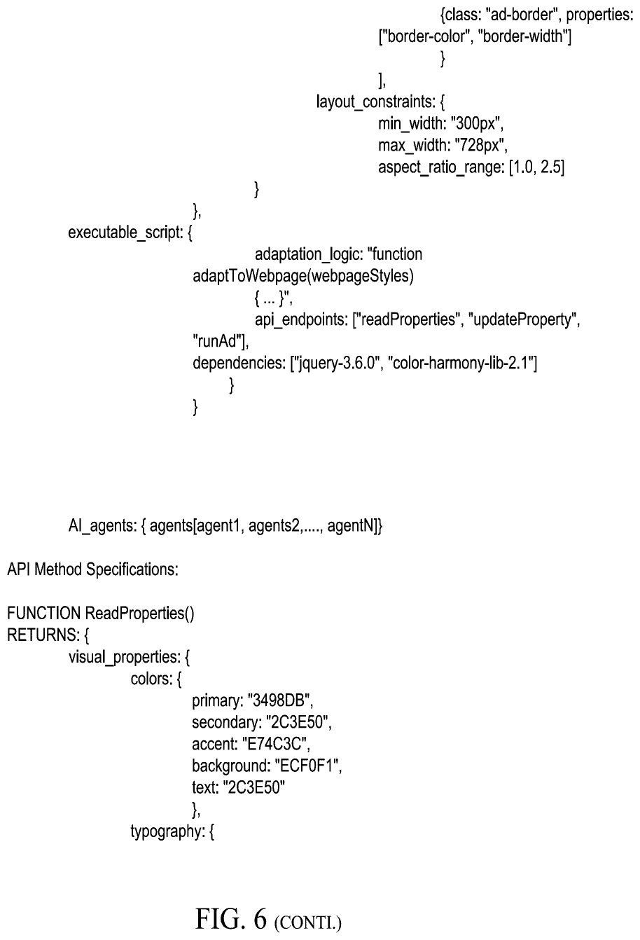

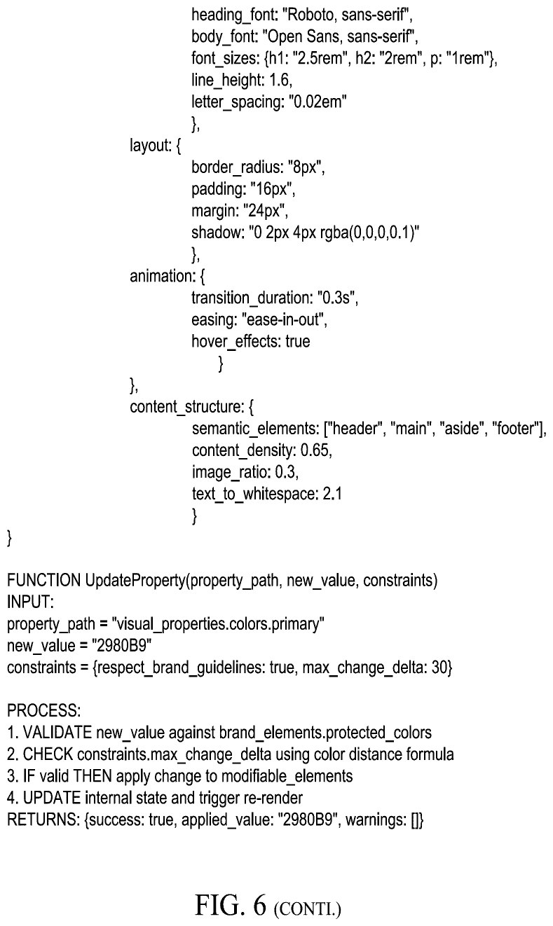

Reference is now made to FIG. 6 which illustrates an example standardized format of source CHA 20 (in this example using JSON format). As discussed herein above, schema reader 1411 may read the specific schema and when it needs to extract parameters it is simply reading the values from the keys defined in the structure. Key categories may include:
Protected_colors,
Protected_logos,
Protected_fonts, and
Brand_guidelines (e.g., minimum logo size, contrast ratios).

Interface and event handler 141 may also look for the modifiable_elements block. This is the “allow list” that tells AI engine 12 which specific parts of source CHA 20 are open for adaptation. The list may include:
CSS classes: like ad-background or ad-text, which can have their properties (e.g., background-color, font-family) changed.
Layout constraints: rules like min_width and max_width that define the display CHA 152's responsive behavior.
Core assets: schema reader 1411 may know to look in the assets block to find the file paths for the CHA's core visual content, such as images and video.

Schema reader 1411 may store this information together with source CHA 20's live state in asset and state manager 142.

Asset and state manager 142 may store, manage, and provide access to all the data that defines source CHA 20, from its unchangeable brand identity to its live, adapted appearance as described herein above. Asset and state manager 142 may be configured to maintain multiple states of a CHA, including its original state as defined by the source CHA 20, its live adapted state after modification by adaptation module 143, and a history of previous states. This state versioning enables advanced functionalities such as reverting changes, performing A/B testing between different adaptations, and providing detailed historical data to analytics gatherer 1413. Furthermore, asset and state manager 142 may perform active asset management beyond simply storing file paths. This may include caching of core assets to improve loading performance, performing on-the-fly asset optimization such as resizing images or transcoding videos for the target display context, and managing dependencies called by the CHA's executable script. It will be appreciated that a critical function of asset and state manager 142 is the enforcement of brand integrity, acting as a gatekeeper to validate any proposed state change against the protected brand elements and guidelines retrieved from the CHA schema to ensure that no adaptation violates core brand identity. It may thus ensure transactional integrity for state modifications, confirming that a set of adaptation commands is applied atomically and does not result in a corrupted or inconsistent state.

Schema reader 1411 may further store this information in CMS 18 so further use so that source CHA 20 is known to system 100 for further use.

Event listener 1412 may monitor display CHA 152 for user interactions in order to generate a suitable landing page 5 as described in more detail herein below.

Analytics gatherer 1413 may collect aggregated and projected data on its effectiveness (for example how may clicks it received) from display CHA 152. This data may be used to provide information for an analytics sub-system that may be associated with system 100.

Once schema reader 1411 has determined source CHA 20's schema, interface, and event handler 141 may then instruct adaptation module 143 to determine what changes need to be made to source CHA 20 in order to harmonize with page 151.

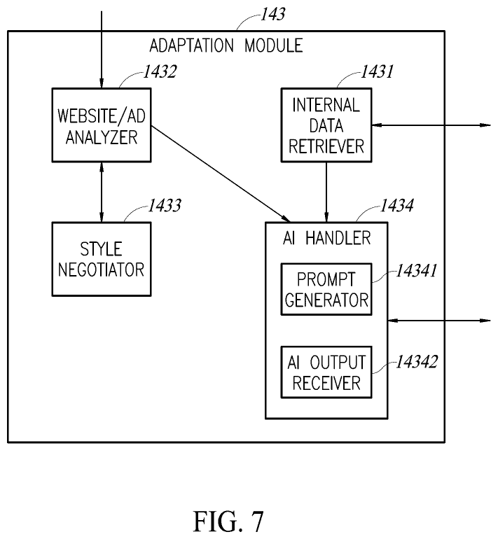

Reference is now made to FIG. 7 which shows the elements of adaptation module 143. Adaptation module 143 may comprise an internal data retriever 1431, a website/ad analyzer 1432, a style negotiator 1433 and an AI handler 1434. AI handler 1434 may further comprise a prompt generator 14341 and an output receiver 14342.

It will be appreciated that if website 15 has been built using WBS 10, internal data retriever 1431 may query CMS 18 to retrieve website 15 attributes such as global color palette (primary, secondary, accent colors), global font pairings (heading fonts, body fonts), the name and properties of the theme or template being used and any site-wide style rules, such as default button styles or corner radiuses. As discussed herein above, CMS 18 may be a content management system functioning as a centralized data repository within WBS 10 responsible for storing, managing, and providing access to all customer data, including information related to their websites and the components involved.

If website 15 is external to WBS 10, then website/ad analyzer 1432 may analyze website 15 to determine a profile for page 151 from either the page 151 URL or from its Document Object Model (DOM) Object.

In this scenario, website/ad analyzer 1432 may begin by deconstructing the foundational code of page 151, which may involve parsing its structural hierarchy and extracting all associated styling rules to understand the page's basic construction. Subsequently, website/ad analyzer 1432 may perform a detailed color analysis by identifying the computed colors of every visible element and analyzing background images to determine a dominant color palette, weighting colors based on their visibility and the size of the area they occupy. It may then conduct a typography analysis, which may involve identifying the font families, sizes, weights, and spacing patterns to establish a clear typographic hierarchy. The analysis may further extend to detecting layout patterns, where website/ad analyzer 1432 may measure common spacing values, identify recurring corner styles, and recognize underlying grid structures. Finally, website/ad analyzer 1432 may map the semantic structure of page 151 to understand the purpose of different content sections, detect navigation patterns, and locate potential zones for advertisement placement, culminating in a detailed style profile that AI engine 12 may use for the adaptation process as described in more detail herein below. It will be appreciated that website/ad analyzer 1432 may use algorithms and methodologies generally known in the art.

Prompt generator 14341 may generate a suitable prompt for AI engine 12 for recommendations for changes to the color gamut, fonts and other branding design or layout elements of source CHA 20 in order to convert it to display CHA 152 for display on page 151.

Prompt generator 14341 may receive a comprehensive profile of page 151 either from internal data retriever 1431 or website/ad 1432 accordingly.

Prompt generator 14341 may then query asset and state manager 142 to retrieve contextual data for source CHA 20 from CMS 18. As discussed herein above, this data (that has been read from source CHA 20) may include a complete set of brand protection rules, such as protected colors, fonts, and logos, as well as a list of elements within the ad that are explicitly marked as modifiable. To ensure a consistent and effective instruction format, Prompt generator 14341 may retrieve a predefined prompt template from CMS 18. This template may serve as a structured scaffold, containing designated placeholders for the various pieces of information it has gathered.

Prompt generator 14341 may then assemble the final prompt by systematically populating the template's placeholders. It may inject the style profile of page 151, providing AI engine 12 with a detailed breakdown of the target design language, including its dominant color palette, typographic hierarchy, and layout patterns. It may also embed source CHA 20's brand protection rules and the list of modifiable elements.

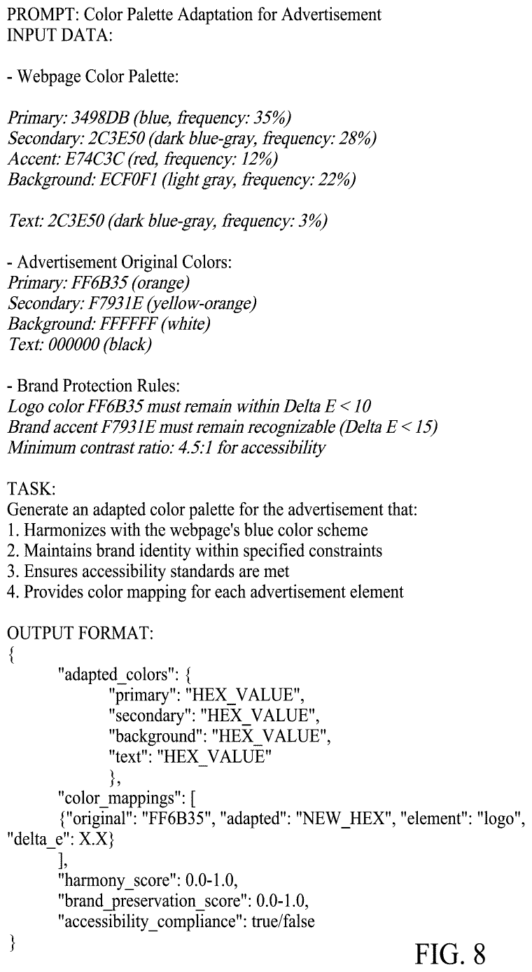

Reference is now made to FIG. 8, which represents a sample prompt used to initiate a call to AI engine 12 to determine adaptation instructions for source CHA 20. In some embodiments, the prompt supplied to AI engine 12 may follow a structured format that includes, for example, (i) a representation of the style profile of website 15, (ii) brand protection rules for source CHA 20, and (iii) an explicit listing of elements of source CHA 20 that are permitted to be modified. The prompt may further specify an output format for the adaptation commands, such as a set of key value pairs describing changes to be applied to particular style attributes of the chameleon advertisement.

AI engine 12 may comprise one or more proprietary machine learning models hosted on the same servers that operate WBS 10, allowing for direct and low-latency communication with other internal components like chameleon ad handler 14 and CMS 18. As discussed herein above, AI engine 12 may suggest amendments such as color palettes and branding objects to source CHA 20 for display as display CHA 152.

In an alternative embodiment, AI engine 12 may function as a logical gateway or proxy that manages communication with an external, third-party AI service provider such as a large language model (LLM) or other trained model. In this configuration, when prompt generator 14341 dispatches a prompt, AI engine 12 may receive the request, format it into a secure API call, and transmit it to a specialized external service for processing. Upon receiving the adaptation commands from the external service, AI engine 12 may then route the response back to the appropriate internal module, such as chameleon ad handler 14.

AI engine 12 may receive the structured prompt from AI handler 1434, which may contain a detailed style profile of website 15 and the contextual data of source CHA 20, including its brand protection rules as is illustrated in FIG. 8 back to which reference is now made. Upon processing this prompt, AI engine 12 may analyze the inputs using one or more trained machine learning models as described herein above and may output a set of specific commands to modify source CHA 20's visual properties.

It will be appreciated that AI engine 12 may develop this capability through a comprehensive training process designed to learn the principles of visual harmony between advertisements and webpages. For example, the training may involve a supervised learning approach where AI engine 12 learns from a large webpage and advertisement pairs that have been rated for visual harmony by professional designers. In another embodiment, AI engine 12 may employ a reinforcement learning model, where an agent iteratively learns to modify ad properties like color and font, receiving a reward based on a score that considers both improvements in visual harmony and adherence to brand preservation rules. Furthermore, AI engine 12 may utilize a generative adversarial network, in which one model generates adapted advertisements while a second model evaluates the quality of the integration, thereby improving both models through an adversarial process. The training may also leverage transfer learning, using foundational models pre-trained on general design principles such as color theory and typography, which may then be fine-tuned on advertisement-specific datasets. After processing an input prompt through these trained models, AI engine 12 may generate the final set of adaptation commands, which it may then transmit back to output receiver 14342 for execution.

It will be appreciated that as well as the ability of source CHA 20 to change its presentation according to website 15 environmental factors, AI engine 12 may further consider parameters and editing history (including end-user feedback) derived from other websites of the same user or other users (while protecting other users'privacy, IP rights, and other legal rights) as stored in CMS 18.

Once AI engine 12 has provided recommendations, they may be processed by AI output receiver 14342 which may receive and parse the output from AI engine 12 (for example in JSON format) and create files, meta data, and data to send to AI output receiver 14342. Each instruction may target a specific property within the source CHA 20's live state data structure and provide the new value. For example, an instruction may specify the update of a background color property to a new hexadecimal value. AI output receiver 14342 may instruct asset and state manager 142 to commit these changes by overwriting the old values in their live state with the new, approved ones. Ad handler 21 may be then instructed to implement them. As discussed herein above, ad handler 21 may be the API wrapper for source CHA 20.

As discussed herein above, ad handler 21 may comprise an associated CHA AI 22 to provide artificial intelligence support for source CHA 20. CHA AI may have full knowledge of source CHA 20's parameters such as the color gamut, the fonts, and other branding elements. When ad handler 21 receives recommendations from AI engine 12 how to adapt to harmonize with website 15, CHA AI 22 may ensure that the recommendations can be implemented and may prevent any adaptations that cannot be made. It may further handle multilingual issues, by transforming the language of source CHA 20 to the language of the website 15. CHA AI 22 may be an open-source instance (e.g., Llama) or a proprietary one (e.g., ChatGPT) and may specifically be trained on the source CHA 20 s context to ensure brand consistency. CHA AI 22 may access this internal context, in addition to instructions received from the ad handler 21 and information obtained via Retrieval-Augmented Generation (RAG) and other mechanisms.

It has access to this internal context, in addition to instructions received from the wrapper and information obtained via Retrieval-Augmented Generation (RAG) and other mechanisms.

In an alternative embodiment CHA AI 22 may provide interface and event handler 141 with source CHA 20's graphic and behavior parameters instead of schema reader 1411.

In the context of adapting a website to an advertisement, a user may interact with displayed display CHA 152 on page 151. It will be appreciated that regardless of the variety and specificity of their ads, most brands direct their traffic to a singular, often generic, landing page or website (typically managed by the brand owner). These one-size-fits-all destinations do not resonate with the end user's unique interaction with the brand. For example, an end user being drawn in by a specific Instagram ad about a limited-time product, only to be directed to a generic homepage rather than a focused, personalized landing page for that product. The momentum of their engagement is lost, and the brand misses a prime conversion opportunity.

In this scenario, event listener 1412 may continuously monitor a display CHA 152 for user interactions, such as a click event. As discussed herein above, analytics gatherer 1413 may gather analytics regarding the event accordingly. Upon detecting such an event, event listener 1412 may instruct adaptation module 143 to initiate a workflow for generating a personalized web asset (page, site, section, etc.), which would serve as a dedicated landing page, adapted to the design language or other elements of display CHA 152. The personalized landing page may be a newly generated page or an updated one.

Adaptation module 143 may gather the complete context for display CHA 152 and request a full snapshot of the live state of display CHA 152 from asset and state manager 142 (its current colors, fonts, content, etc.) if display CHA152 has been previously processed (as discussed herein above in relation to concept 1). If display CHA 152 is a foreign entity to WBS 10 from an external source and not a compliant chameleon ad, it may not have an ad handler 21 and therefore its state is not managed by asset and state manager 142.

In this scenario, website/ad analyzer 1432 may analyze display CHA 152 to understand its visual style by deconstructing the content of display CHA 152 to identify its core visual and brand identity. Website/ad analyzer 1432 may perform a color analysis and extract all colors from display CHA 152's content and cross-reference them with the brand's official palette to distinguish brand-specific colors from general design colors. Similarly, it may perform a typography detection process to identify all fonts used and check them against a brand database and guidelines to mark official brand fonts as protected. Lastly, website/ad analyzer 1432 may perform a contextual analysis using Natural Language Processing (NLP) to scan any text in display CHA 152 to find and preserve key brand messaging, such as brand names, slogans, or taglines. The output of website/ad analyzer 1432 may be a structured map of display CHA 152's essential and protected elements, which serves as the blueprint for generating a visually and contextually consistent landing page.

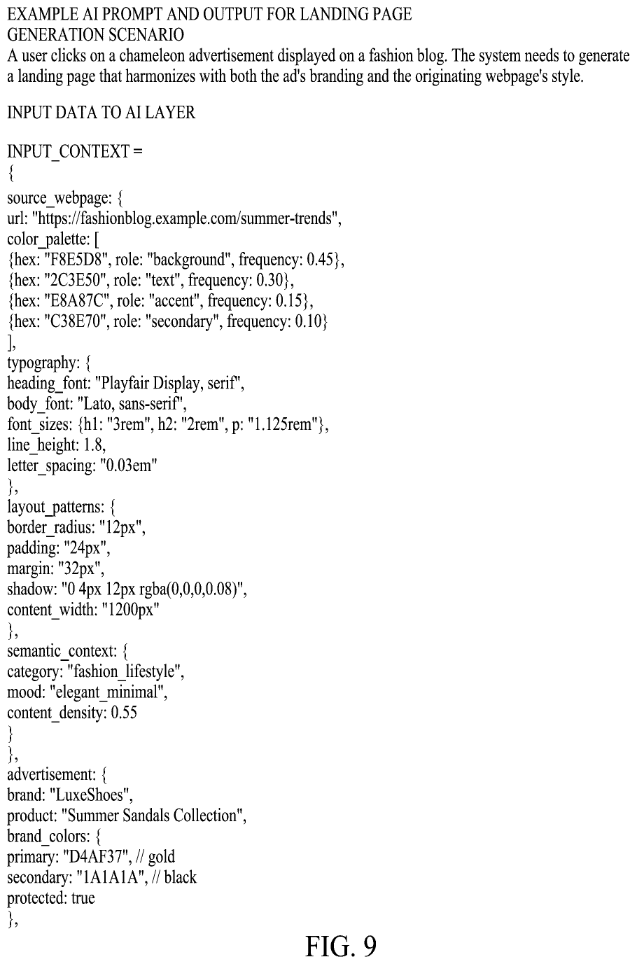

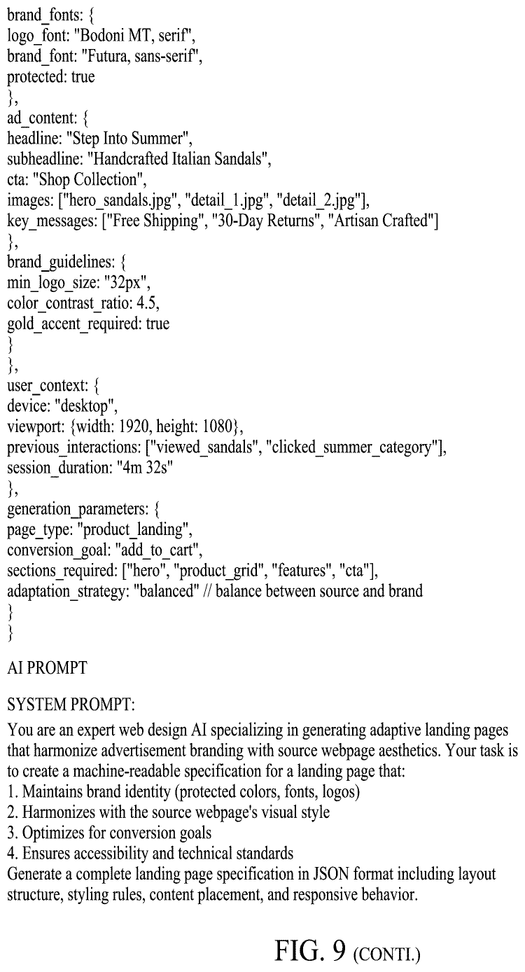

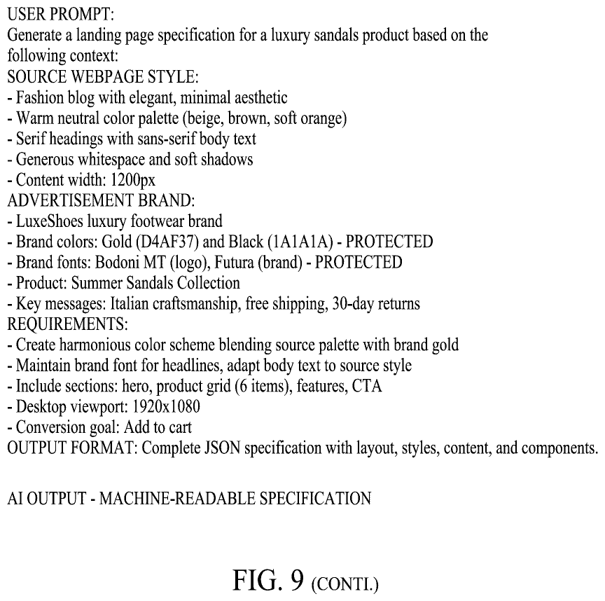

Website/ad analyzer 1432 may then pass the profile to prompt generator 14341 to create a suitable prompt for AI engine 12 in order to generate a blueprint for the new, personalized landing page 5. The prompt may, for example, describe the identified brand elements, style constraints, and desired page structure, and may request that AI engine 12 output a machine-readable specification of a landing page layout and associated styling rules. Reference is now made to FIG. 9, which provides an example prompt to initiate a call to the AI engine of FIG. 1 to determine instructions for a creating a landing page that is suitably adapted to display CHA 152.

AI engine 12 may interpret the received display CHA 152 profile, distinguishing between its core identity and its stylistic elements. It may meticulously respect any “protected” brand elements identified by website/ad analyzer 1432 such as official logos, specific brand colors, and proprietary fonts, ensuring these are preserved to maintain brand integrity. It then uses modifiable elements, such as general color schemes, secondary fonts, and textual content like slogans and product descriptions, as the creative raw material for landing page 5.

AI engine 12 may translate these raw materials into machine-readable instruction sets to provide a definition of a content structure and a set of associated styling rules, such as a JSON object, that meticulously defines every aspect of the new page. It may contain the complete HTML structure for the layout, a full set of CSS rules dictating the color palette, typography, and spacing, and all the content data to be populated.

AI output receiver 14342 may receive this instruction set and may transmit this instruction set to site generation system 13 which may receive and parse these instructions, and then construct the final, fully adapted landing page by assembling the HTML, applying the specified CSS, and inserting the content, thereby rendering landing page 5.

It will be appreciated that although the discussion herein refers to landing page 5 (in singular form), system 100 may also be applied to modify or generate an extended “landing page” consisting of multiple interconnected landing pages (i.e., a complex landing page set or funnel which interacts with the user).

It will be appreciated that websites today are designed to offer a uniform experience to all visitors, regardless of their individual preferences. This one-size-fits-all approach diminishes the effectiveness of advertising efforts. Marketing teams often create multiple ad variations to attract diverse customer segments with varying motivations. For instance, when selling speakers, some customers might prioritize design, while others focus on quality and technical specifications.

Currently, these ads may all direct traffic to the same generalized website, which fails to cater to the distinct preferences of each customer segment. The common but inefficient solution is to create specific landing pages for each ad and ad variation, which is both costly and resource intensive.

System 100 may enable the creation of different landing pages for the same advertisement to accommodate different user preferences originating from the same website.

For example, originating from a single website A, a specific ad (source CHA 20) may be incorporated in the same way concept #1 is described, in part by passing meta data M to the source CHA 20 to create display CHA 152. When choosing to see more details on display CHA 152 (such as by clicking inside the ad), a new landing website B, created in real-time, is presented. This new website may be considered a chameleon website which is created by using the meta data M.

It will be appreciated that the process may enable the creation of different preferences and landing pages originating from website A.

An example flow may include the following stages:

Create website A as the originator and G as the target landing site.

Adapt a source CHA C to website A to create a display CHA C using metadata M passed from website A.

When display CHA C is clicked, create or adapt in real-time a variant of website G (concept 2), using metadata M and other data from display CHA C. This adaptation or creation could be limited to a part of website G (i.e., only some pages or page sections) and may include the creation of completely new websites, websites pages or page sections thus creating a landing site that is personalized to the originating website and user.

In an alternative embodiment, for the page-part adaptation as described above, system 100 may adapt only a partial area or section of page 151. For example, system 100 may adapt an embedded, merged, or added site presence within an existing page, such as a dedicated section, widget, or frame that is generated or updated in response to a CHA while the remainder of the page remains under control of the original site design.

It will be appreciated that concepts 1 and 2 may also be combined by operating both sides so as to create greater harmony between display CHA 152 and website 15. For example, if a display CHA C is about to be displayed on page P, which is radically different from page A (e.g., having radically different color palettes). CHA C and page P may “negotiate” via an agreed protocol, so that both CHA C and page P modify their color palettes to be closer to each other, and thereby more harmonious (while still using a different palettes).

In this scenario, website/ad analyzer 1432 may analyze both display CHA 152 and website 15 as discussed herein above and provide both style profiles to style negotiator 1433. Style negotiator 1433 may perform an optimization calculation or apply any suitable known algorithm such as a mediator algorithm configured to determine a set of modifications to the color palettes and other style parameters of both display CHA 152 and website 15. The algorithm may minimize a divergence metric between the style profiles subject to constraints that penalize deviations from protected brand elements, thereby yielding a set of changes that reduces the visual discrepancy between the advertisement and the website while preserving each party's brand identity.

Prompt generator 14341 may then create two different structured prompts for AI engine 12 (such as the example prompts in FIGS. 8 and 9 back to which reference is now made), one for instructions on how to modify display CHA C and another for a blueprint for an updated landing page 5. Then site generation system 13 may generate a new harmonized landing page and chameleon ad handler 14 may instruct ad handler 21 to update display CHA 152 accordingly as discussed herein above.

Thus, system 100 provides adaptive integration of advertisements with web assets. It achieves this through a dual-concept approach, first by transforming a source chameleon advertisement object into a display chameleon advertisement object that is visually harmonized with a target webpage, based on an analysis of the webpage's style profile. Second, upon detecting a user interaction with said display chameleon advertisement object, said system automatically constructs a new, personalized landing page using data extracted from said display chameleon advertisement object as a blueprint. This process creates a direct visual and contextual continuation of the user's journey, thereby overcoming the limitations of static ad placements and generic conversion funnels, and constitutes a specific improvement to the functionality of digital advertising systems by enhancing user engagement and optimizing performance.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The inventive elements discussed hereinabove may be implemented on a suitable apparatus. This apparatus may be specially constructed for the desired purposes, or it may comprise a computing device or system typically having at least one processor and at least one memory, selectively activated or reconfigured by a computer program, code or prompt. The resultant apparatus when instructed by program, code or prompt may turn the general purpose computer into inventive elements as discussed herein. The program, code or prompt may define the inventive device in operation with the computer platform for which it is desired. Such program, code or prompt may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing programs, code or prompts. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for adaptive advertisement integration with webpages, said system comprising:
at least one processor;
a website building system (WBS) running on said at least one processor; said WBS comprising:
a chameleon ad handler configured to analyze visual properties of a target webpage to create a webpage style profile and to read the schema of a source chameleon advertisement object (CHA);
an artificial intelligence (AI) engine to generate adaptation commands for said source CHA according to said webpage style profile and schema to generate a display CHA visually aligned with said target webpage according to said webpage style profile;
wherein said chameleon ad handler is further configured to detect a user interaction with said display CHA, and in response to said user interaction, to analyze properties of said display CHA to create a display CHA style profile and to instruct said AI engine to generate a blueprint for a personalized landing page according to said display CHA style profile; and
a site generation system configured to construct said personalized landing page according to said blueprint.

2. The system of claim 1, wherein said source CHA comprises an ad handler with an associated CHA AI configured to provide artificial intelligence support for said source CHA.

3. The system of claim 1, wherein said chameleon ad handler comprises:
an interface and event handler to manage data and command signals between said system, said source CHA, said webpage and said display CHA;
an asset and state manager to store and manage data defining said source CHA; and
an adaptation module configured to determine changes required to visually align said source CHA with said target webpage, said adaptation module to further determine said blueprint for said landing page according to said display CHA style profile.

4. The system of claim 3, wherein said interface and event handler comprises:
a schema reader configured to read said schema of said source CHA; and
an event listener configured to detect said user interaction with said display CHA.

5. The system of claim 3, wherein said adaptation module comprises:
an internal data retriever configured to retrieve attributes of said target webpage from a local content management system;
a website/ad analyzer configured to analyze at least one of: said target webpage and said display CHA to determine a webpage style profile and a display CHA style profile accordingly;
a style negotiator configured to perform an optimization calculation that reduces visual discrepancy between said display CHA and said target webpage by determining a set of modifications for both while preserving each party's brand identity; and
an AI handler configured to generate a prompt for said AI engine according to at least one of: said webpage style profile and said display CHA style profile.

6. The system of claim 1, wherein said schema of said source chameleon advertisement object comprises a set of protected brand elements and a list of modifiable elements.

7. The system of claim 5, wherein said AI handler comprises:
a prompt generator configured to assemble a structured prompt for said AI engine by populating a predefined template with at least one of: said webpage style profile and said display CHA style profile; and
and an output receiver configured to receive and parse an output from said AI engine, said output comprising said adaptation commands.

8. The system of claim 1, wherein said blueprint for said personalized landing page is a machine-readable instruction set comprising a definition of a content structure and a set of associated styling rules for said personalized landing page.

9. The system of claim 5, wherein said website/ad analyzer performs at least one of: deconstructing foundational code of said target webpage to parse its structural hierarchy; performing a color analysis of visible elements to determine a dominant color palette; and conducting a typography analysis to identify font families, sizes, and weights to establish a typographic hierarchy.

10. The system of claim 3, wherein said asset and state manager is further configured to maintain multiple states of said source CHA, said multiple states comprising its original state, its live adapted state after modification by said adaptation module, and a history of previous states, thereby enabling A/B testing between different adaptations.

11. A method for adaptive advertisement integration with webpages, said method comprising:
analyzing visual properties of a target webpage to create a webpage style profile;
reading the schema of a source chameleon advertisement object (CHA);
generating using artificial intelligence, according to said webpage style profile and schema, adaptation commands for said source CHA to generate a display CHA visually aligned with said target webpage; and
in response to a user interaction with said display CHA, analyzing properties of said display CHA to create a display CHA style profile; and
generating using artificial intelligence, a blueprint for a personalized landing page according to said display CHA style profile; and
constructing said personalized landing page according to said blueprint.

12. The method according to claim 11, wherein said generating said display CHA further comprises providing artificial intelligence support within said source CHA to ensure said adaptation commands are implemented according to brand consistency rules.

13. The method according to claim 11, further comprising:
managing data and command signals between said source CHA, said target webpage, and said display CHA;
storing and managing data defining said source CHA; and
determining changes required to visually align said source CHA with said target webpage.

14. The method according to claim 13, wherein said managing data and command signals comprises:
reading said schema of said source CHA; and
detecting said user interaction with said display CHA.

15. The method according to claim 13, wherein said determining changes required to visually align said source CHA with said target webpage comprises:
retrieving attributes of said target webpage from a local content management system;
analyzing at least one of: said target webpage and said display CHA to determine said webpage style profile and said display CHA style profile accordingly;
performing an optimization calculation that reduces visual discrepancy between said display CHA and said target webpage by determining a set of modifications for both while preserving each party's brand identity; and
generating a prompt according to at least one of: said webpage style profile and said display CHA style profile.

16. The method according to claim 11, wherein said schema comprises a set of protected brand elements and a list of modifiable elements, and wherein said generating adaptation commands is further based on said protected brand elements and said list of modifiable elements.

17. The method according to claim 15, wherein said generating a prompt comprises:
assembling a structured prompt by populating a predefined template with at least one of: said webpage style profile and said display CHA style profile; and
receiving and parsing an output comprising said adaptation commands.

18. The method according to claim 11, wherein said generating a blueprint comprises generating a machine-readable instruction set comprising a definition of a content structure and a set of associated styling rules for said personalized landing page.

19. The method according to claim 15, wherein said analyzing comprises at least one of:
deconstructing foundational code of said target webpage to parse its structural hierarchy;
performing a color analysis of visible elements to determine a dominant color palette; and
conducting a typography analysis to identify font families, sizes, and weights to establish a typographic hierarchy.

20. The method according to claim 13, wherein said storing and managing data further comprises maintaining multiple states of said source CHA, said multiple states comprising its original state, its live adapted state, and a history of previous states, thereby enabling A/B testing between different adaptations.
